(19) United States
(12) Patent Application Publication
(10) Pub. No.: US 2015/0134354 A1
(43) Pub. Date: May 14, 2015

(54) SYSTEM AND METHOD FOR REDUCING HEALTHCARE-ASSOCIATED INFECTIONS BASED ON HAND HYGIENE

(71) Applicant: DebMed USA LLC, Charlotte, NC (US)

(72) Inventors: Paul Alper, Mt. Pleasant, SC (US); Martin McGonagle, Chandler, AZ (US); Heather McLarney, Charlotte, NC (US)

(21) Appl. No.: 14/539,843

(22) Filed: Nov. 12, 2014

Related U.S. Application Data
(60) Provisional application No. 61/903,101, filed on Nov. 12, 2013.

(51) Int. Cl. G06F 19/00

(52) U.S. Cl. CPC G06F 19/327; G06F 19/325
USPC 705/2

(57) ABSTRACT

A system and method for improving healthcare facility operation by improving hand hygiene compliance and reducing healthcare-associated infections and their associated costs is disclosed. The method may compare the financial benefit of improved hand hygiene compliance to the cost of improving compliance by, for example, providing electronic monitoring that reports hand hygiene within the facility. The costs of current hand hygiene monitoring and of current HAIs are determined, the cost of an electronic hand hygiene monitoring system and the cost benefits of improved hand hygiene compliance are determined, and an electronic hand hygiene monitoring system is installed and implemented within the healthcare facility where improved hand hygiene compliance will benefit the facility.

### RELATED APPLICATIONS

Priority is claimed from provisional application U.S. Ser. No. 61/903,101, filed Nov. 12, 2013, now pending. The entire specification and all the claims of that provisional application are hereby incorporated by reference.

### BACKGROUND

Healthcare-associated infections, also known as HAIs, have been an ever increasing challenge in healthcare facilities. Healthcare facilities have battled MRSA (methicillin-resistant staphylococcus aureus), VRSA (vancomycinresistant staphylococcus aureus), and other drug resistant micro-organisms for many years. HAIs can result from transmission of bacteria, viruses, and other disease causing micro-organisms from various sources such as a patient or environmental surfaces to another patient or surface via the hands of healthcare workers. Such transmission can cause infection of a patient who was previously not infected. These problems have been more apparent in recent years. It is estimated that approximately 2,000,000 such HAIs occur annually in the U.S. alone, resulting in about 100,000 deaths. The costs associated with these infections are estimated in the billions of dollars.

Healthcare institutions devote significant efforts and resources to prevention and control of the spread of HAIs. One important aspect of such efforts is directed to ensuring that healthcare professionals comply with hand hygiene best practices. Hand hygiene can be accomplished by washing with soap and water and by using liquids such as a sanitizing product which does not require water or rinsing of the product. Hygiene products that are used for hand hygiene are commonly dispensed by dispensers that are located where hand hygiene is desired.

Best practices for hand hygiene in a healthcare setting can be based on the five moments of hand hygiene identified by the World Health Organization. Those five moments for hand hygiene actions 10 are shown in FIG. 1. Specifically, the five moments for hand hygiene actions are: 1) before patient contact; 2) before performing an aseptic task; 3) after body fluid exposure risk; 4) after patient contact, and 5) after contact with patient surroundings. These five moments provide guidelines for hand hygiene within a healthcare setting. Those guidelines establish times (the 5 Moments or opportunities) during the provision of patient care when hand hygiene should occur.

The necessity and benefits of hand hygiene are not limited to healthcare institutions. Hand hygiene is important for virtually all workplaces to maintain a healthy environment and to limit spread of bacteria, viruses and other disease causing micro-organisms both of which are essential for worker health. Hand hygiene is essential for certain activities and services in addition to healthcare including food preparation and food service. Hand skin care products can promote worker health in avoiding and treating hand skin conditions that can reduce worker performance and productivity.

Compliance with guidelines or recommended practices for hand hygiene may be monitored by a number of approaches including direct (manual) observation, tracking product consumption, and more recently, electronic monitoring systems. Measuring compliance requires knowledge of both the number of hand hygiene events that have occurred and the number of recommended hand hygiene opportunities at which a guideline or recommended practice indicate that hand hygiene should have occurred. Manual observation permits both the actual and recommended hand washing events to be counted (although the sample size is often quite small and not statistically significant), not only at the overall level, but also in detail based on understanding which recommended hand hygiene opportunities have actually occurred.

In healthcare institutions, monitoring compliance by healthcare workers with hand hygiene best practices can indicate whether HAIs may be occurring due to poor hand hygiene compliance. One way to monitor compliance with hand hygiene best practices is to monitor use of hand hygiene product dispensers at locations at which hand hygiene should occur. A system for monitoring use of dispensers is disclosed by U.S. Pat. No. 8,427,323, and dispensers and a wireless communication system that report dispenser use are disclosed by U.S. patent application Ser. Nos. 12/823,475 and 13/427,467 all of which are assigned to the owner of this application and are incorporated herein by reference.

FIG. 2 is a diagram of a direct (manual) observation monitoring system 12. The direct (manual) observation monitoring system 12 includes a plurality of dispensers 14 that dispense a washing fluid that is used by workers 16 to wash their hands. Ideally, for healthcare workers 16, the dispensers 14 will be located at or near locations where each moment shown in FIG. 1 occurs. An observer 18 monitors compliance at each of the moments and enters the compliance data at terminal 20, which is in communication with a central server 22. Central server 22 is also in communication with other data entry terminals, such as terminal 24 located at another location in the hospital. The central server 22 maintains hand hygiene compliance records for the hospital.

Direct (manual) observation has a number of key deficiencies and problems. Notably, it is very expensive to implement, and results in only a very small percentage of the total number of hand hygiene opportunities being observed, typically too small a number to be statistically significant. Further, direct (manual) observation carries a risk of overstatement of compliance due to the impact on the behavior being observed (this is known as the Hawthorne effect). For example the overstatement of compliance by direct (manual) observation in a recent study: Quantification of the Hawthorne effect in hand hygiene compliance monitoring using an electronic monitoring system: a retrospective cohort study. Srigley J A, Furness C D, Baker G R, Gardam M. BMJ Qual Saf. 2014 Jul. 7. pii: bmjqs-2014-003080. doi: 10.1136/bmjqs-2014-003080. [Epub ahead of print] was demonstrated to be 300%. Another prior study—Compliance with hand hygiene on surgical, medical, and neurologic intensive care units: direct observation versus calculated disinfectant usage. Scheithauer S, Haefner H, Schwanz T, Schultze-Steinen H, Schiefer J, Koch A, et al. Am J Infect Control 2009; 37:835-41 demonstrated such overstatement to be 275%. Such inaccuracy in reporting real hand hygiene compliance in an institution creates inaccurate hand hygiene practice evaluation and does not provide a reliable basis for institution management.

In addition to making management of an institution difficult, lack of accurate reporting of hand hygiene compliance within an institution makes it difficult to justify acquisition and installation of an electronic monitoring system to monitor hand hygiene compliance. Accordingly, the inventors have recognized a need for a method and system that provides an accurate indication of hand hygiene compliance and an accurate estimate of both the hand hygiene and cost benefit impact of an electronic hand hygiene monitoring system. Institution management is improved by accurate hand hygiene compliance information and also, when improvement is required, accurate indication of the improvement that is hand hygiene compliance improvement and the resulting cost benefit. Such overall improvements are enabled by the data from an electronic hand hygiene monitoring system.

### BRIEF DESCRIPTION OF THE DRAWINGS

FIG. 1 illustrates the five moments for hand hygiene actions established by the World Health Organization.

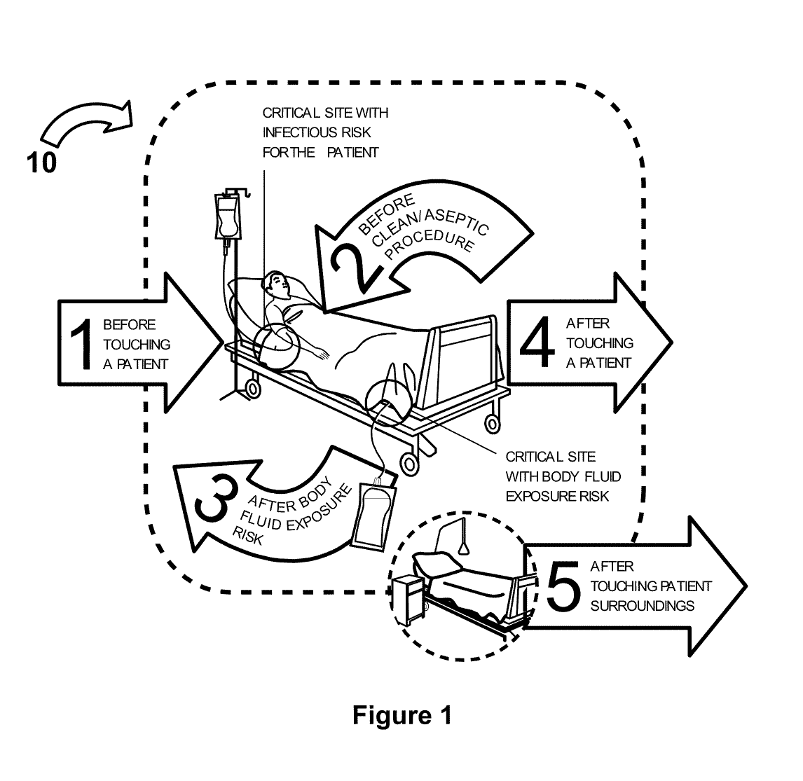

FIG. 2 is a diagram of an exemplary direct (manual) observation monitoring system.

FIG. 3 is a block diagram of a system that enables improvement of healthcare facility operation by determining hand hygiene compliance and indicating opportunities for reducing healthcare-associated infections

FIG. 4 shows one example of an introduction page that may be used in the system of FIG. 3.

FIG. 5 shows one example of a hospital profile page that may be used in the system of FIG. 3.

FIG. 6 shows one example of a CMS data page that may be used in the system of FIG. 3.

FIG. 7 shows one example of the current hand hygiene compliance rate leading to a projected infection rate page that may be used in the system of FIG. 3.

FIG. 8 shows one example of a detailed current state of infections (resulting from the current hand hygiene compliance) page that may be used in the system of FIG. 3.

FIG. 9 shows one example that may be used in the system of FIG. 3 of a demonstration of predicted cost of infections based on published studies, which may be customized.

FIG. 10 shows one example that may be used in the system of FIG. 3 of a demonstration of predicted impact on Mortality and Increased Length of Stay based on published studies, which may be customized.

FIG. 11 shows one example of an impact of an electronic monitoring system impact page that may be used in the system of FIG. 3.

FIG. 12 shows one example that may be used in the system of FIG. 3 of the calculation of program cost inputs and the healthcare facility's return on investment.

FIG. 13 shows the calculation that may be performed by the system of FIG. 3 of the costs associated with a healthcare institution performing direct (manual) observation.

FIG. 14 shows one example of an electronic monitoring system cost calculation page that may be used in the system of FIG. 3.

FIG. 15 shows one view of the cost to benefit calculation for a healthcare institution over a five year period that may be performed by the system of FIG. 3.

FIG. 16 shows a page of adjunct financial benefits derived from implementation of an electronic monitoring system that may be used by the system of FIG. 3.

FIG. 17 shows one example of an adjunct clinical benefits page that may be used in the system of FIG. 3.

FIG. 18 is a diagram showing a wireless information collection system that may be used to electronically monitor hand hygiene.

### SUMMARY

A system and method for improving healthcare institution operation by improving hand hygiene compliance and thereby reducing healthcare-associated infections is disclosed. The method comprises determining the current compliance with existing hand hygiene guidelines or best practices within a healthcare institution, determining the potential for improved hand hygiene compliance to impact incidence of healthcare-associated infections, and identifying actions within the institution that will improve hand hygiene compliance within the institution. The method may further comprise identifying installation of an electronic hand hygiene monitoring system within the institution as an action that will improve hand hygiene within the institution. The method may further comprise using the hand hygiene monitoring system to identify locations and circumstances of failure to follow hand hygiene guidelines and best practices within the institution. The method may also include determining the costs to the institution of poor compliance with existing hand hygiene guidelines or best practices within the institution. The method may further comprise determining the return on investment resulting from actions to improve hand hygiene compliance based on avoidance of costs for the institution due to poor hand hygiene compliance.

In one implementation, the method comprises determining compliance of a healthcare institution with hand hygiene guidelines or best practices based on one or more of 1) direct (manual) hand hygiene compliance monitoring; and 2) other monitoring data information available for the healthcare institution. The healthcare institution hand hygiene compliance is compared to compliance rates that may be achieved based on improved monitoring of hand hygiene to determine the improvement in the institution's hand hygiene compliance based on use of the electronic hand hygiene observation. The method further comprises determining healthcare institution's current rates of healthcare-associated infections. The method may further comprise in this implementation determining the cost benefit to the institution of improved hand hygiene compliance by determining the difference in cost to the institution of the cost of hand hygiene at the current compliance and the cost to the institution of improved hand hygiene compliance and the effects of improved hand hygiene to decrease rates of HAIs within the healthcare institution. The method may further comprise in this implementation determining the return on investment of an electronic hand hygiene monitoring system by determining the difference between the cost to the institution of the direct (manual) hand hygiene monitoring system and the cost of acquisition, installation and operation of the electronic hand hygiene monitoring system.

In one implementation, a system for determining compliance with hand hygiene guidelines and best practices includes a user interface, a first database storing data corresponding to the manual hand hygiene monitoring implemented by a health facility, a second database storing reported data, and a processing system having memory storage. The memory storage includes code executable by a processor to: 1) use data from one or both of the first database and second database to determine a baseline for the facility's hand hygiene compliance and 2) determine the cost of the institution's hand hygiene compliance and the monitoring thereof. The memory may further include code executable to 3) receive data corresponding to the hand hygiene compliance corresponding to the use of an electronic hand hygiene monitoring system and 4) comparing the hand hygiene compliance corresponding to use of an electronic hand hygiene monitoring with the baseline for the facility's hand hygiene compliance. The method may further comprise determining the cost of lack of hand hygiene compliance that may be reduced when accurate determination of hand hygiene compliance from electronic hand hygiene monitoring system baseline is available to identify opportunities for hand hygiene improvement.

### DETAILED DESCRIPTION

Embodiments will be described more fully hereinafter with reference to the accompanying drawings, in which embodiments are shown. Like reference numbers refer to like elements throughout. Other embodiments may, however, be in different forms that are not limited to or by the embodiments set forth herein. Rather, these embodiments are examples. Rights based on this disclosure have the full scope indicated by the claims.

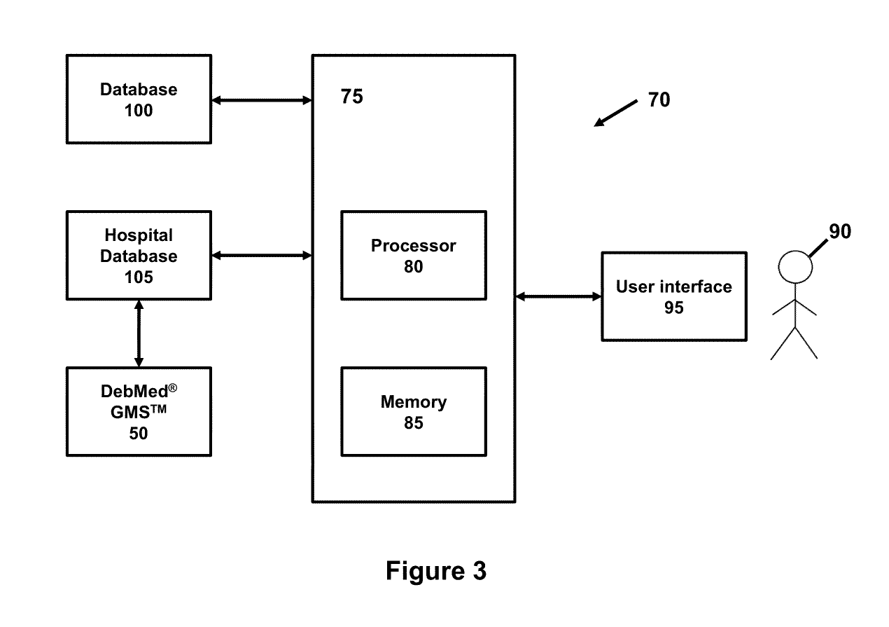

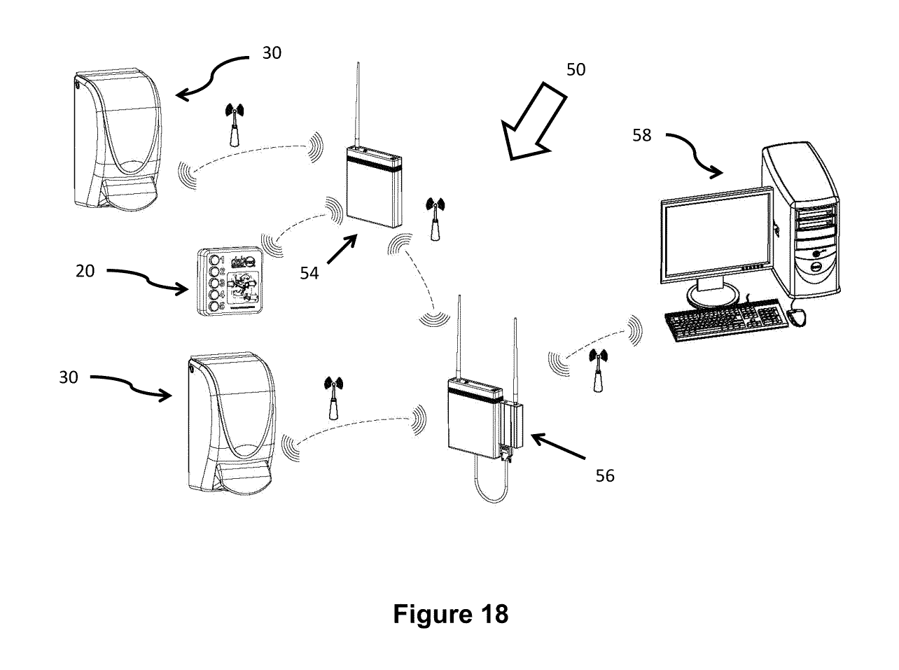

FIG. 3 is a block diagram of a system 70 that may be used to determine a hospital's compliance with hand hygiene guidelines and that may accept data from an electronic hand hygiene monitoring system 50 such as the one shown in FIG. 18. In this example, the system 70 includes a processing system 75 that includes a processor 80 and electronic memory storage 85. The electronic memory storage 85 includes code that is executable by processor 80 to facilitate entry and presentation of data to a user 90 through a user interface 95 to implement the methods of the present invention.

The processing system 75 may communicate with one or more databases. As shown by FIG. 3, the processing system 75 may be configured to access a database 100, a hospital database 105, and one or more other databases that provide or supplement data used by the processing system 75 to determine the hand hygiene compliance of the healthcare institution.

The database 100 may include data published by studies of hand hygiene in healthcare institutions that may be used to estimate the impact that the hand hygiene compliance for a healthcare institution has on HAI rates and their associated costs.

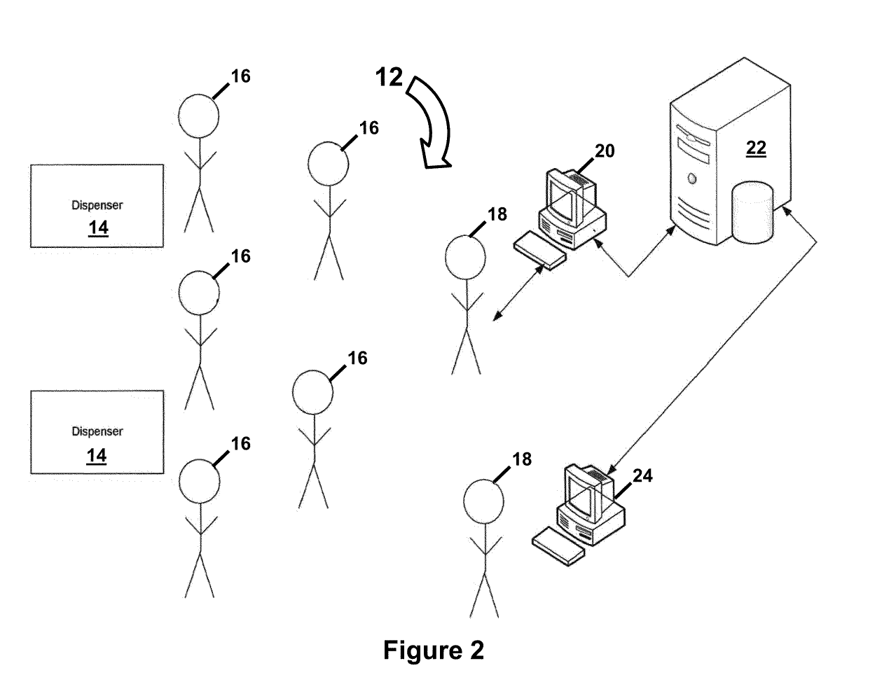

The hospital database 105 may include hand hygiene compliance data that originates from the healthcare institution. That data may be directly entered by hospital workers, such as healthcare workers 16 of FIG. 2, reporting hand hygiene during clinical activity. The compliance data stored in the hospital database 105 may additionally, or in the alternative, be obtained by manual observation or other monitoring of hand hygiene compliance such as by observers 18 of FIG. 2. An electronic monitoring system may be temporarily installed to evaluate the healthcare institution's hand hygiene compliance and provide data that may be stored in database 105. Data from an electronic monitoring system may also be used to compare electronically monitored hand hygiene to manual observation of hand hygiene compliance.

Information is entered into the system 70 by and presented to the user 90 using a number of different “pages” displayed by the user interface 95. In the exemplary system 70, each page corresponds to a display of information, data entry fields, activation buttons, etc., that are presented to the user 90. Data for use by the methods according to the present invention may be manually entered by the user 90. Such data may include data that is publicly accessible over the Internet from the Centers for Medicare & Medicaid Services (CMS) website. That data includes information provided by healthcare facilities. Healthcare facilities, such as hospitals, provide the data that is available from the CMS website. Statistical information corresponding to infection issues arising in healthcare facilities may also be obtained from the CMS website for input into the system 70.

### Introduction Page

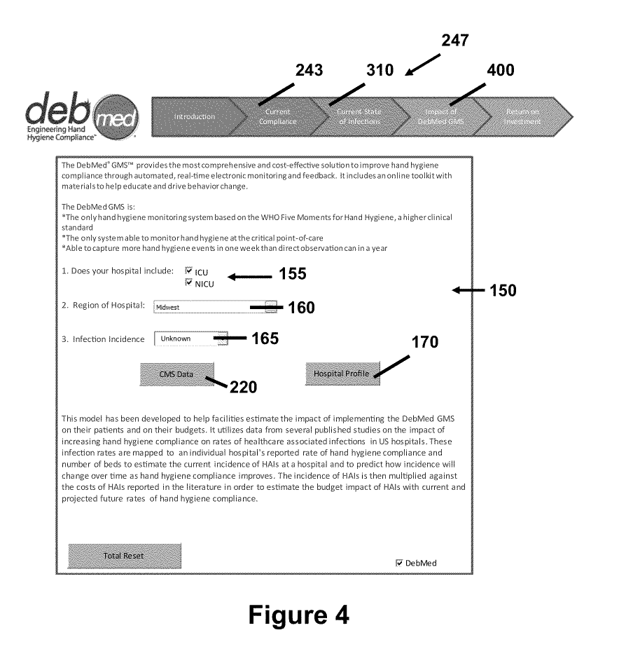

FIG. 4 shows one example of an introduction page 150 that may be used in the system 70. The introduction page 150 provides some basic information relating to the system 70, and provides means for entering initial information into the system 70.

Whether the hospital has an intensive care unit (ICU), a neonatal intensive care unit (NICU), or both is selected using selection boxes 155. Infection rates and costs for these hospital units are included in the final results. ICU and NICU typically have higher rates of infection than other areas of the hospital where lower patient acuity exists.

The region in which the hospital is located is entered in field 160. The selected hospital region provides adjustments to the cost of healthcare associated infections to account for higher/lower costs in different areas of the country.

Infection incidence for the hospital is entered in field 165. The entered infection incidence determines whether the data used to evaluate the impact of hand hygiene compliance improvement and return on investment in electronic monitoring of hand hygiene compliance is calculated using either data from the system model (which may be based on published studies) or from data originating at the hospital. The field 165 may include the following selections:

Select “Unknown” when information on the infection rates at the hospital are unavailable and system 70 data (which may be based on published studies) must be used.

Select “Some” when some information about infection rates at the hospital is available. Specifically, when the hospital can provide the total number of HAIs per year.

Select “Detailed” when granular information is available from the hospital on infection rates, including both the overall number of infections in the General Hospital, ICU and NICU as well as details about specific infections (i.e. rates for CLABSI, C. diff, MRSA, etc.)

### Hospital Profile Page

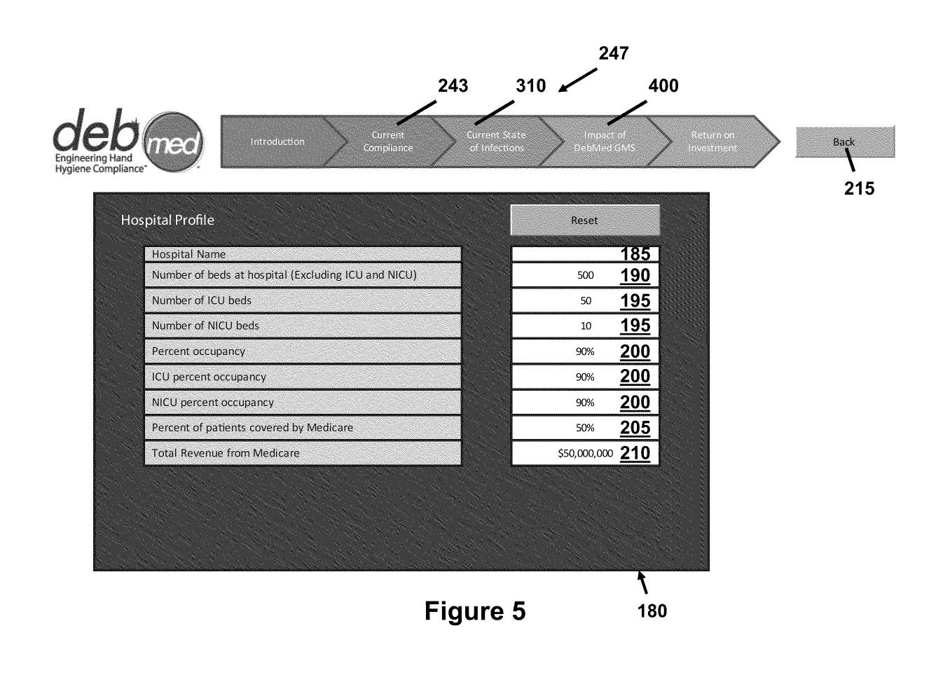

Actuation of the hospital profile button 170 on the introduction page 150 directs the system 70 to the hospital profile page 180 shown in FIG. 5. Details used to calculate the total number of bed days at the hospital per year at the hospital are entered on this page. If data is not entered on this page, the system 70 will not correctly calculate the desired results.

The hospital profile page 180 may include the following fields:

The name of the hospital is entered in field 185. This name will also appear on a PDF document which can be stored and printed by the hospital.

The number of beds at the hospital, excluding ICU and NICU, is entered in field 190. If the ICU/NICU boxes have been selected at 155 of the introduction page 150, the number of beds for each of these units is separately entered in fields 195.

The percent occupancy of each unit is separately entered in each respective field 200.

The percent of Medicare patients and the annual revenue of the hospital from Medicare are entered in fields 205 and 210, respectively. These numbers can be estimates, and are used to calculate the impact of Value Based Purchasing on the hospital revenue.

Once the hospital profile page 180 has been completed, the Back button 215 is actuated to return to the system 70 to the introduction page 150.

### CMS Data Page

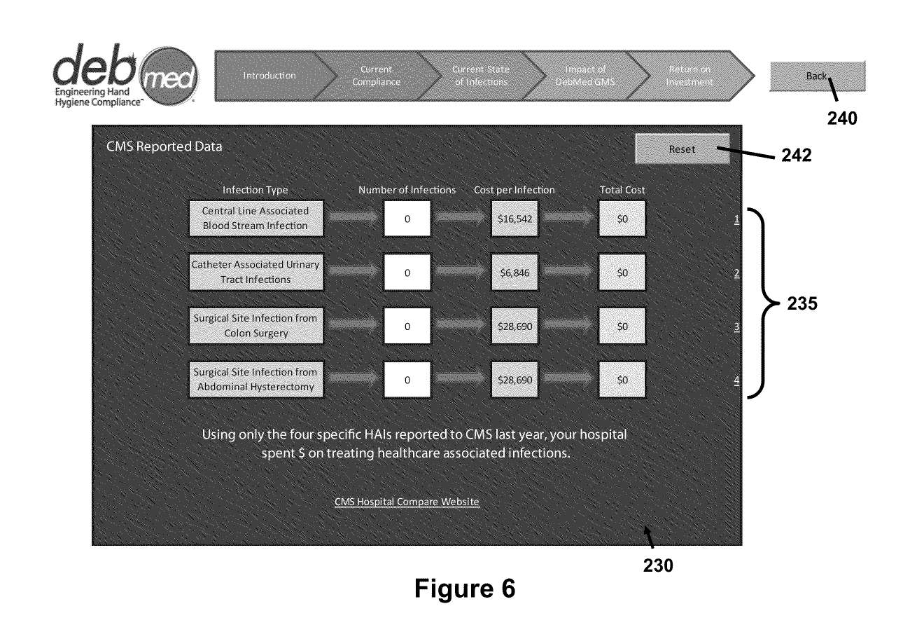

The CMS data button 220 on the introduction page 150 may be actuated to use some information available through CMS to provide the hospital with a limited picture of costs associated with HAIs. If the hospital has provided direct information on the number of infections, the CMS data need not be used. Available CMS data may be entered manually by use of a user interface 95 as shown by FIG. 3. CMS data may be entered on a CMS data page 230 such as the one shown in FIG. 6. The CMS data page 230 may be used to provide some information on the occurrence of certain HAIs. The exemplary CMS data page 230 is based on data for four specific HAIs: 1) central line associated blood stream infections, 2) catheter associated urinary tract infections, 3) surgical site infections from abdominal hysterectomy, and 4) surgical site infections from colon surgery. The costs associated with each HAI is obtained based on published studies that are identified by tables that may be accessed using hyperlinks 235. Once all data has been entered on the CMS data page 230, the system 70 presents the total dollar value associated with these HAIs only at the hospital. Although the CMS data page 230 shown in FIG. 6 only includes four specific infections in this class determination, the hospital may have more than what is reported to CMS and, as such, may have higher HAI costs than those shown on the CMS data page 230. The CMS data page may be updated as CMS modifies which infections are tracked.

### Current Compliance Page

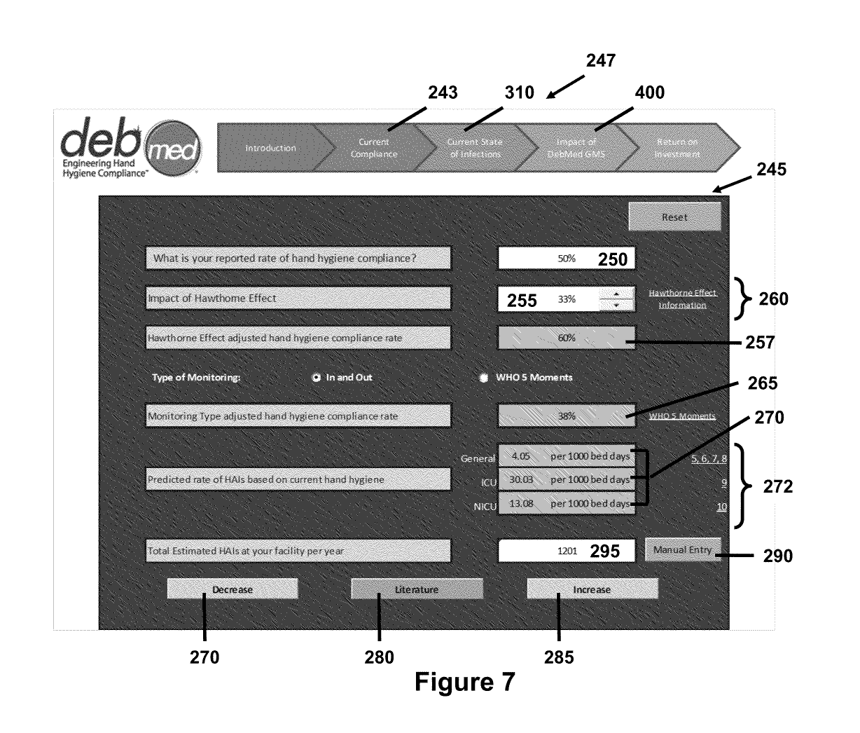

Once the data entries for the CMS data page 230 have been completed, the Back button 240 may be actuated to return the system 70 to the introduction page 150 of FIG. 4. Activation of a Current Compliance button 243 along the navigation pane 247 at the top of the page directs the system 70 to the current compliance page 245 shown in FIG. 7. Information about the current rate of hand hygiene compliance of the hospital is entered on this page. The healthcare institution's current compliance is entered manually based on hand hygiene compliance information that originated at the institution

The current compliance page 245 is shown by FIG. 7. At the top of this page, the rate of hand hygiene compliance reported by the hospital is shown by field 250. Most hospitals overestimate the rate of compliance due to the Hawthorne Effect. Accordingly, once the reported compliance rate has been entered, the system 70 automatically performs a calculation to decrease the reported rate by 33% due to the Hawthorne Effect as shown in box 255; that decrease is based on published research. The Hawthorne effect adjusted compliance rate may be shown by the field 257. The impact of the Hawthorne Effect may be altered using up/down arrows adjacent field 255 to adjust the actual compliance rate to a rate the healthcare institution may comfortably accept. A hyperlink 260 to the right of the adjustment field 255 can be selected to direct the system 70 to provide more information on the Hawthorne Effect and its impact on hand hygiene compliance rates.

Field 265 shows the hand hygiene compliance rate determined by the system 70 when using the WHO 5 Moments (the accepted best practice approach) approach instead of the in/out compliance (Moments 1 and 4). Most hospitals monitor only in/out compliance and, therefore, miss important hand hygiene moments. The WHO 5 Moments hand hygiene compliance rates show hospitals what their actual rate of hand hygiene compliance likely is when the WHO 5 Moments guidelines are followed. In the system 70, the WHO 5 Moments compliance rate is not necessarily used to calculate model results. Rather, it may be included as a talking point to discuss the importance of monitoring at the highest standard of care which means knowing the total number of hand hygiene opportunities according to the standard. The talking point is important because it can help improve facility operations by leading to improved hand hygiene behavior and reduction of HAIs.

If “Unknown” has been selected for infection rates on the introduction page 150, the system 70 will automatically project infection rates in fields 270 based on published studies identified by hyperlinks 272 adjacent to the fields 270. Hyperlinks 272 to the right of these boxes identify the original data sources and provide linked access to the original publications. Across the bottom of the Current Compliance page 245, Decrease/Literature/Increase buttons 270, 280, and 285 respectively provide for slightly increasing and decreasing literature reported rates to better reflect actual hospital rates and customize the page.

The Manual Entry button 290 may be actuated to override the HAI numbers that the system 70 generates. When actuated, the total estimated HAIs at the hospital may be manually entered using a number aligned with hospital experience, data and expectations. If a number that is entered is lower than what has been reported in the literature, a warning will appear, but the model will allow this override and calculate a reduction in HAIs based on this entered rate.

If “Unknown” has been entered in field 165 on the introduction page 150, the total number of infections per year is presented in field 295 at the bottom of the page based on the rates shown by fields 270 and the hospital profile information provided on the Hospital Profile page 180 shown by FIG. 5. The system relies on published data from real world studies on hand hygiene and healthcare-associated infections.

If “Some” or “Detailed” has been entered in field 165 on the introduction page 150, the system enters manual entry mode for the Current Compliance page 245 permitting manual entry of the total number of infections per year into field 295 at the bottom of the page 245. Once this number is entered, the reported rate of HAIs per 1000 bed days will be calculated based on the studies identified by hyperlinks 272. If the entered total number of infections is substantially below what has been reported in the literature, the system 70 will flag a model validation error. Rates will be questioned if the values entered are outside the ranges reported in these studies referenced by hyperlinks 272. If a data validation error is flagged, the number in field 295 should be slightly increased until the data validation requirements are satisfied. However this adjustment to the point of validation requirements being satisfied is not needed to proceed.

### Current State of Infections Page

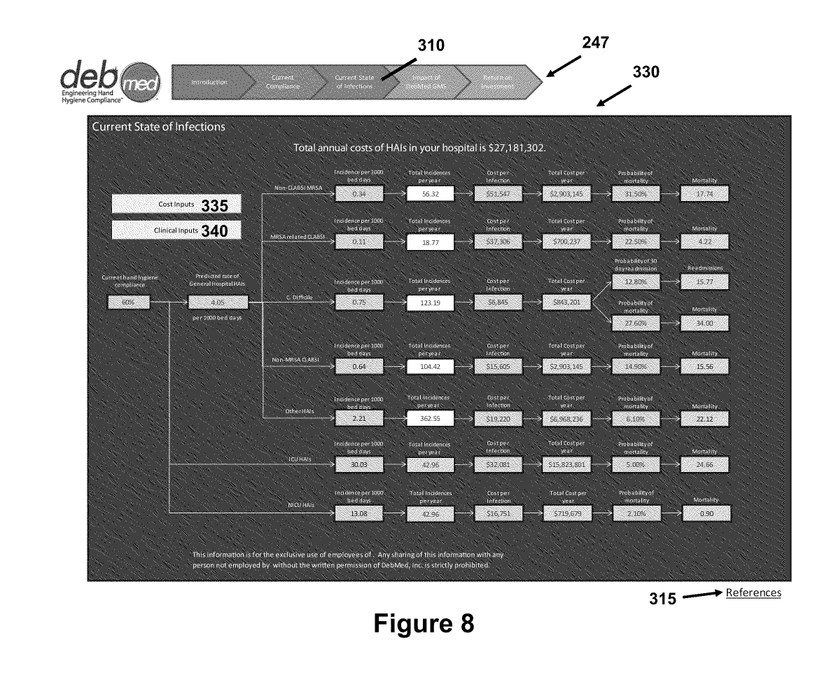

Once information has been entered as described for the foregoing pages, the Current State of Infections button 310 is selected from the navigation pane 247 at the top of the page, which directs the system 70 to display the Current State of Infections page 330 shown by FIG. 8. The Current State of Infections page 330 provides a break out of specific infections, their costs, and mortality outcomes for the hospital. This information provides the hospital with a view of the impact that HAIs have on their budget and patients. At the top of the Current State of Infections page 330, the total annual cost for HAIs is displayed.

If “Unknown” has been entered in field 165 on the introduction page 150, the rate of each identified HAI per year is determined based on the total number of infections and rates derived from literature that is identified by a page that is linked to by References link 315 at the bottom of page Current State of Infections page 330.

If “Detailed” has been selected on the introduction page 150, the number for each specific infection as per hospital data is entered in the corresponding fields of the Current State of Infections page 330. Details are provided for non-CLABSI MRSA (any MRSA infection which is not a central line associated bloodstream infection), MRSA related CLABSI (any CLABSI due to MRSA), C. Difficile and non-MRSA CLABSI (any CLABSI due to bacteria other than MRSA) and all other HAIs. Details are also provided for ICU and NICU HAIs when present.

The Current State of Infections page 330 includes a Cost Input button 335 and Clinical Inputs button 340. Each is a link to a page that presents information relied on as bases for the Current State of Infections page 330.

### Cost Input Page

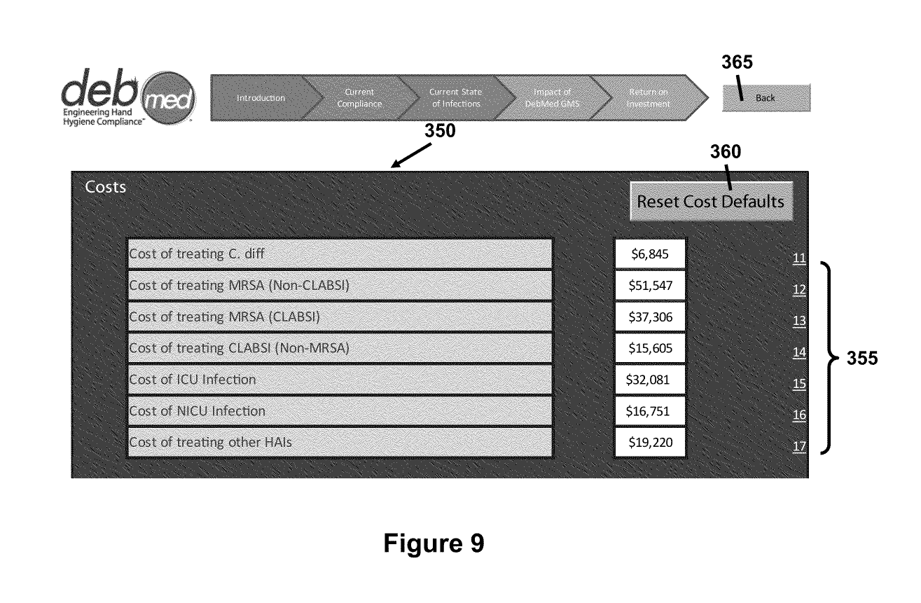

Actuation of the Cost Input button, 335 on the Current State of Infections page 330 directs the system 70 to the cost input page 350 of FIG. 9. The cost input page 350 provides details on costs associated with HAIs identified by the Current State of Infections page 330. Hyperlinks 355 to the right of each infection cost field identified by the page 350 direct system 70 to provide access to the peer reviewed publications used by the system 70 to determine the displayed costs. All costs may be adjusted for inflation to the present year and adjusted to account for regional variation in hospital costs. Further, all costs on the cost input page 335 may be overwritten if a hospital has direct information on the costs of these infections. A Reset Costs button 360 may be used to restore default values. Actuating the Back button 365 directs the system 70 to return to the current state of infections page 330 of FIG. 8.

### Clinical Inputs Page

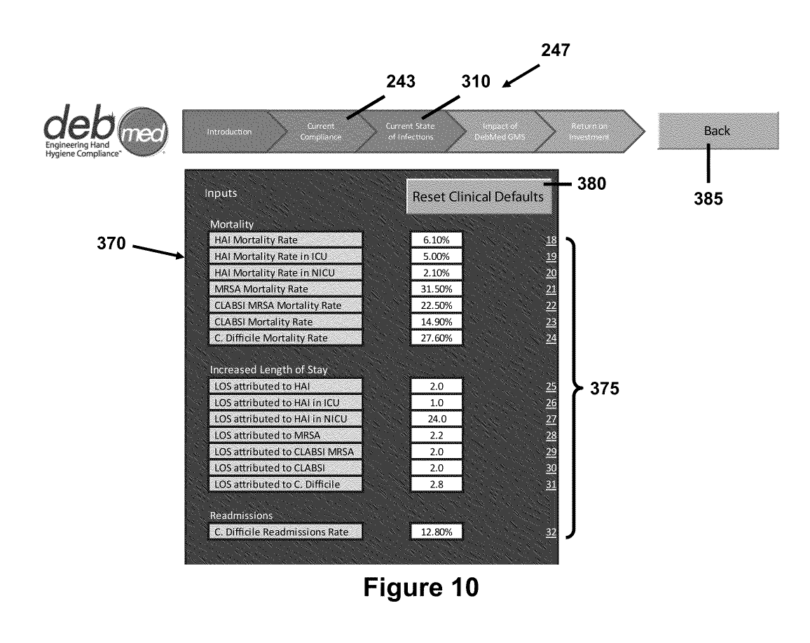

Actuation of the Clinical Inputs button 340 on the Current State of Infections page 330 as shown by FIG. 8, directs the system to display the clinical inputs page 370 shown by FIG. 10. The clinical inputs page 370 contains fields related to mortality due to HAIs, increased length of stay due to HAIs and re-admissions due to HAIs. Hyperlinks 375 to the right of each field direct the system 70 to provide access to studies literature on which these values are based. While the data displayed in the fields of this page are derived from peer reviewed, published studies, all values can be changed to better match the experience, data and expectations of the hospital. Actuating Reset button 380 restores the fields to their default values. Actuating the Back button 385 directs the system 70 to return to the current state of infections page 330 of FIG. 8.

### Impact of GMS Page

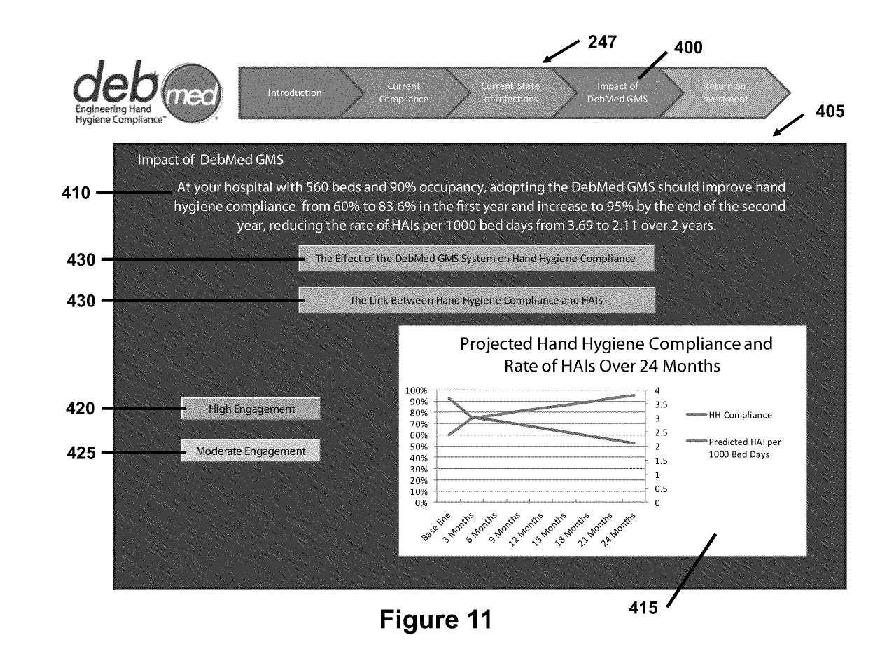

Actuation of the Impact of GMS button 400 on the navigation pane 247 directs the system 70 to the impact of an electronic hand hygiene monitoring system page 405 shown by FIG. 11. Dynamic text 410 at the top of this page articulates the baseline hand hygiene compliance and infection rates as well as estimates of the impact that an electronic hand hygiene monitoring system, an example of which is the DebMed® GMS™ hand hygiene monitoring system, will have on both hand hygiene compliance and HAIs in the hospital in the first two years of use.

The graph 415 depicts changes in hand hygiene compliance and HAI rates visually. Two buttons 420 and 425 to the left of the graph 415 allow adjustment of the rate of hand hygiene compliance improvement. In this regard, “High Engagement” button 420 shows hand hygiene compliance based on an assumption that compliance improves more rapidly due to higher staff engagement with the compliance data over the course of the first two years. “Moderate Engagement” button 425 shows hand hygiene compliance based on an assumption that hand hygiene compliance improves less rapidly over the course of the first two years due to a lower level of engagement with the data. The model assumes that hand hygiene compliance will never be above 95% and is capped at that value.

Two additional buttons 430 on this page provide access to more information on the impact of an electronic monitoring system, that may be the DebMed® GMS™ monitoring system, on hand hygiene and the relationship between hand hygiene compliance and healthcare associated infections. The button 430 labelled “The Link Between Hand Hygiene Compliance and HAIs” links to literature that reports the change in HAIs when hand hygiene compliance is improved. That literature provides bases for the relationships between improved hand hygiene compliance and rate of HAIs shown by graph 415. Those relationships may also be based on other reports of HAI rates when hand hygiene compliance is improved, including based on the use of electronic monitoring.

### Return on Investment Page

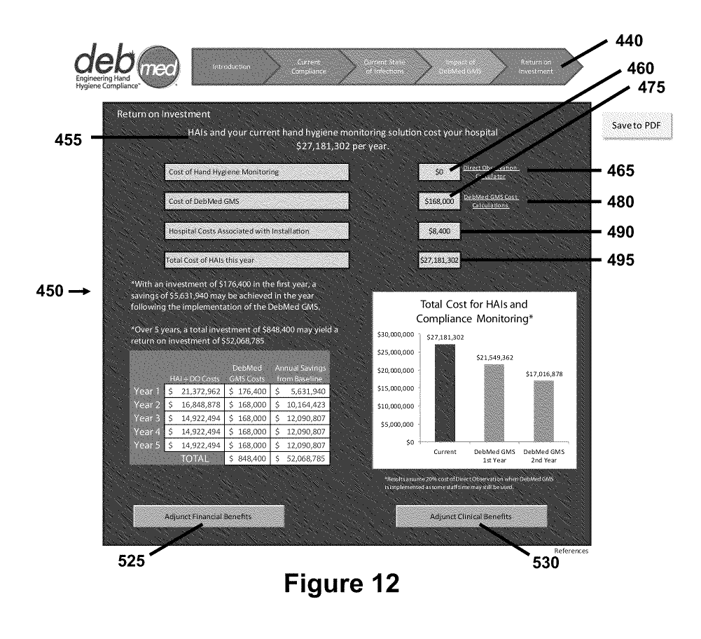

Once the impact of an electronic hand hygiene monitoring system on hand hygiene compliance has been determined, actuation of the Return on Investment button 440 along the navigation pane 247 directs the system 70 to the Return on Investment page 450 of FIG. 12. Dynamic text 455 along the top of this page quantifies the current impact of HAIs.

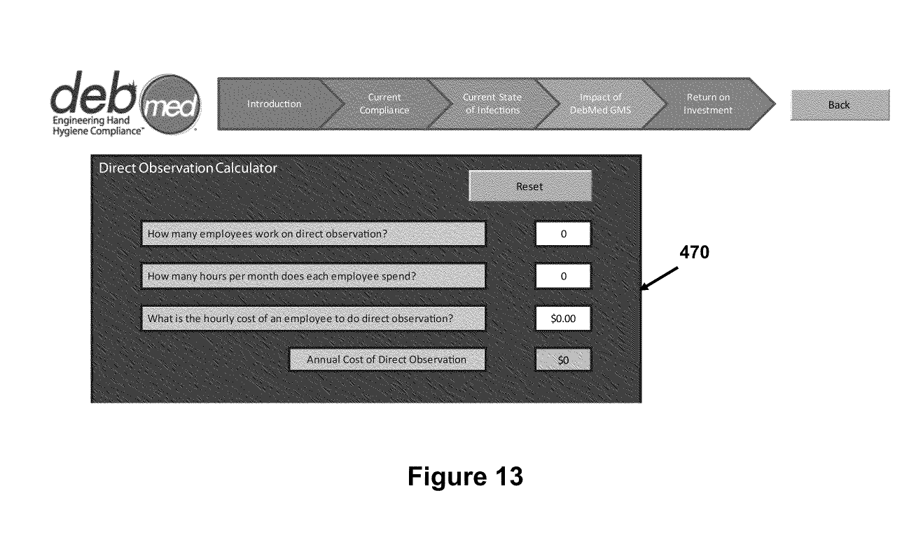

Details on the costs for hand hygiene monitoring are entered in the fields of this page. The annual cost for the current hand hygiene monitoring solution is entered in field 460. Many hospitals, however, do not fully track the costs associated with these monitoring programs since they only consume staff time. To this end, a Direct Observation Calculator hyperlink 465 to the right of field 460 may be actuated, which direct the system 70 to display the direct observation calculator page 470 shown in FIG. 13. Data related to determining the cost of a direct (manual) observation monitoring system may be entered in the fields of page 470. The calculated result is then shown by field 460 of the return on investment page 450.

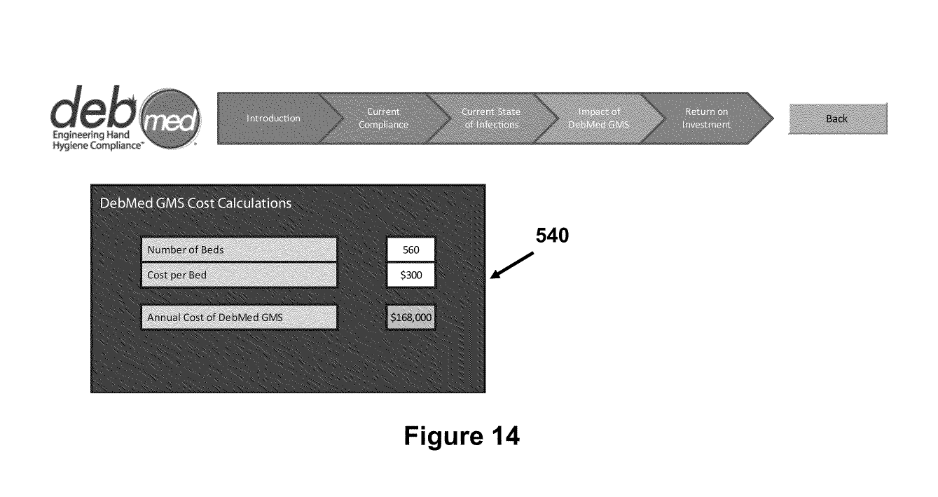

The cost for an electronic hand hygiene monitoring system on page 450 directs the system 70 to automatically calculate the cost of the monitoring system based on the number of beds and is displayed at field 475. Actuating the hyperlink 480 directs the system 70 to display the cost calculator page 540 shown in FIG. 14, where data may be entered based on which the cost of an electronic monitoring system may be determined.

The cost of installation shown in field 490 of the Return on Investment page 450 is intended to capture any hospital borne costs associated with installing the DebMed® GMS™ beyond the costs paid to the manufacture. This may include, for example, staff time to get the program setup.

The total cost of HAIs in the current year is shown in field 495 on the Return on Investment page 450 and corresponds to the costs for both HAIs as well as the costs for direct (manual) observation compliance monitoring programs.

### Total Cost and Compliance Monitoring Page

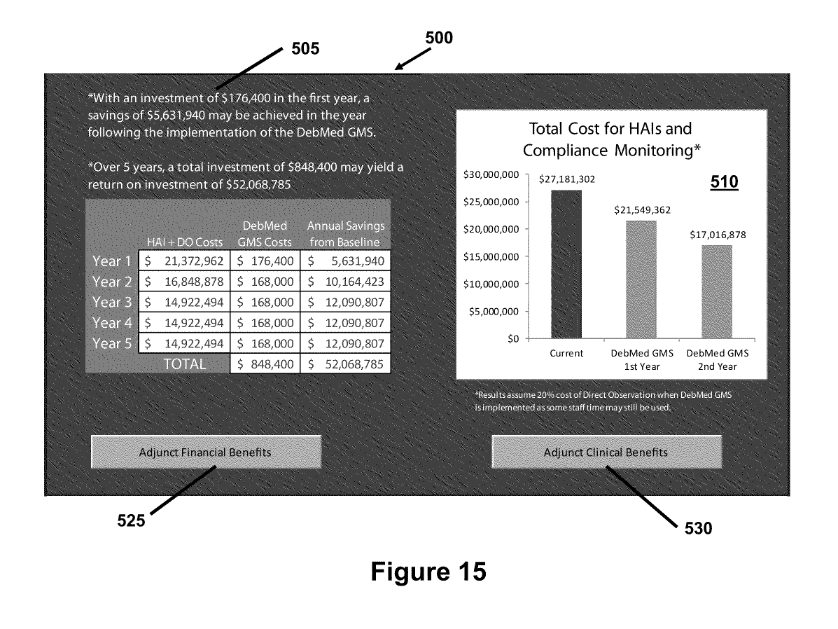

Specific details relating to the total cost may be displayed on the total cost and compliance monitoring section of page 450 as shown by FIG. 15. Dynamic text 505 articulates the costs, potential savings and return on investment of the DebMed® GMS™. A graph 510 provides the costs for HAIs and hand hygiene compliance monitoring under the current scenario and for the first and second year with DebMed GMS. First year costs are based on the reduction in the rate of HAIs as hand hygiene improves. In the second year, it is assumed that maximum hand hygiene compliance has been achieved and will remain fairly stable going forward.

The total costs for the DebMed® GMS™ monitoring system scenario shown in FIG. 14 is based on two amounts. The first column labelled HAI+DO costs includes estimated costs due to HAIs and 20% of the current costs for direct (manual) observation based on a reduced level of manual observation to account for the fact that some staff time will still be needed to oversee the program. If the hospital has indicated that their direct observation program is no cost, the system 70 will not add further dollars to the DebMed® GMS™ scenario for staff management time.

A Save to PDF button (shown by FIG. 11) directs the system 70 to save the information on this page in electronic PDF format. The file may be saved to the same location as the model and use the name of the hospital entered on the hospital profile page 180 as the file name.

### Adjunct Financial Benefits Page

Two additional buttons 525 and 530 at the bottom of page 450 direct the system 70 to pages showing more details on the potential benefits of the DebMed® GMS™. Actuation of button 525 directs the system 70 to display the adjunct financial benefits page 560 shown in FIG. 15. The adjunct financial benefits page 560 provides some details on additional ways that the DebMed® GMS™ can positively impact hospital revenue.

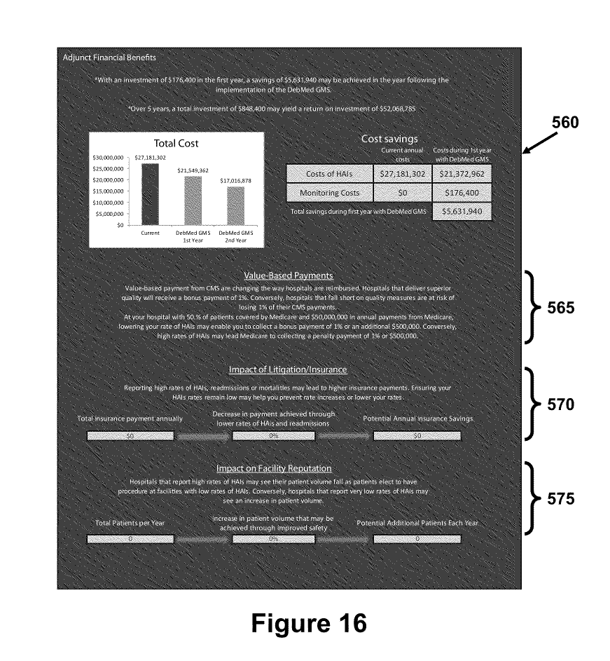

The adjunct financial benefits page 560 shown by FIG. 16 provides some tools to facilitate discussion on other areas of hospital revenue that may be impacted by improved hand hygiene compliance. To this end, Value Based Purchasing text 565 includes calculations made for a new system under CMS which rewards or penalizes hospitals for meeting or failing to meet several quality benchmarks. Beginning in 2015, a hospital's rate of catheter-associated blood stream infections will become part of the calculation to determine these payments. Under value based purchasing, hospitals stand to gain or lose up to 2% of their revenue from CMS. The Value Based Payment text 565 included in the model used in the system 70 provides a quantification of what that sum may be using the lower rate of 1%.

Reporting lower rates of HAIs, 30 day readmission, and in-hospital mortality may reduce the insurance premiums paid by the hospital. The text and fields of section 570 allows the hospital decision maker to input the total annual insurance payment and determine the savings that may be achieved through an adjustment of that payment with the insurer.

A facility reputation section 575 allows the hospital to explore the impact of lower rates of HAIs on their patient volume. As patients have become more aware of hospital quality issues, such as HAI rates, patients undergoing elective procedures will often seek out the facility with the best patient outcomes. Improving reported rates for HAIs may allow hospitals, particularly those in areas with heavy competition, to gain more patients.

### Adjunct Clinical Benefits Page

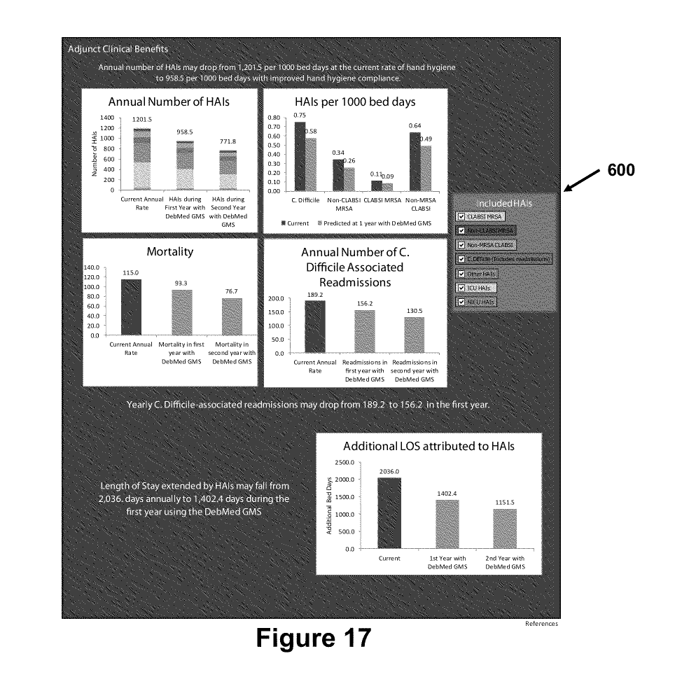

Adjunct clinical benefits may be provided on the adjunct clinical benefits page 600 shown in FIG. 17. The adjunct clinical benefits page 600 provides details on patient outcomes associated with HAIs, including mortality and increased length of stay. Among other things, the adjunct clinical benefits page 600 may display the estimated decrease in specific HAIs due to hand hygiene compliance improvement. Data on mortality, readmissions, and length of stay resulting from HAIs may also be presented here.

As used by the present embodiment, studies and literature relied on are set out by Table I below.

| Source | | |
|---|---|---|
| Number | Citation | Input |
| 1 | Shorr A, Tabak Y, Killian A, et al. | Cost of CLABSI |
| | Healthcare-associated bloodstream | Infection |
| | infection: A distinct entity? Insights | |
| | from a large US database. Critical | |
| | Care Med, 2006. 34(10): 2588- | |
| | 2596. | |
| 2 | Roberts R, Scott D, Hota B, et al. | Cost of Catheter |
| | Costs Attributable to Healthcare- | Associated Urinary |
| | Acquired Infection in Hospitalized | Tract Infection |
| | Adults and a Comparison of | |
| | Economic Methods. Medical Care, | |
| | 2010.48(11): 1026-1036. | |
| 3 | Carboneau C, Benge E, Jaco M, et | Cost of Surgical |
| | al. A lean Six Sigma Team Increases | Site Infection from |
| | Hand Hygiene Compliance and | Colon Surgery |
| | Reduces Hospital-Acquired MRSA | |
| | Infections by 51%. Journal for | |
| | Healthcare Quality, 2010. 32(4): 61- | |
| | 71. | |
| 4 | Carboneau C, Benge E, Jaco M, et | Cost of Surgical |
| | al. A Lean Six Sigma Team Increases | Site Infection |
| | Hand Hygiene Compliance and | from Abdominal |
| | Reduces Hospital-Acquired MRSA | Hysterectomy |
| | Infections by 51%. Journal for | |
| | Healthcare Quality, 2010. 32(4): 61- | |
| | 71. | |
| 5 | Lederer J, Best D, Hendrix V. A | Compliance Effect |
| | Comprehensive Hand Hygiene | on MRSA |
| | Approach to Reducing MRSA | |
| | Health Care-Associated Infections. | |
| | The Joint Commission Journal on | |
| | Quality and Patient Safety, 2009. | |
| | 35(4): 179-185. | |
| 6 | Kirkland K, Homa K, Lasky R, et al. | Compliance Effect |
| | Impact of a hospital-wide hand | on C. Difficile |
| | hygiene initiative on healthcare- | |
| | associated infections: results of an | |
| | interrupted time series. BMJ Qual | |
| | Saf, 2012. 21: 1019-1026. | |
| 7 | Kirkland K, Homa K, Lasky R, et al. | Compliance Effect |
| | Impact of a hospital-wide hand | on HAIs |
| | hygiene initiative on healthcare- | |
| | associated infections: results of an | |
| | interrupted time series. BMJ Qual | |
| | Saf, 2012. 21: 1019-1026. | |
| 8 | Shorr A, Tabak Y, Killian A, et al. | Compliance Effect |
| | Healthcare-associated bloodstream | on CLABSIs |
| | infection: A distinct entity? Insights | |
| | from a large US database. Critical | |
| | Care Med, 2006. 34(10): 2588- | |
| | 2596. | |
| 9 | Allegranzi B, Pittet D. Role of hand | Compliance Effect |
| | hygiene in healthcare-associated | on ICU Infections |
| | infection prevention. Journal of | |
| | Hospital Infection, 2009. 73: 305- | |
| | 315. | |
| 10 | Allegranzi B, Pittet D. Role of hand | Compliance Effect |
| | hygiene in healthcare-associated | on NICU Infections |
| | infection prevention. Journal of | |
| | Hospital Infection, 2009. 73: 305- | |
| | 315. | |
| 11 | Song X, Bartlett J, Speck K et al. | Cost of C. Difficile |
| | Rising Economic Impact of | Infection |
| | Clostridium difficile-Associated | |
| | Disease in Adult Hospitalized | |
| | Patient Population. Infection | |
| | Control and Hospital Epidemiology, | |
| | 2008. 29(9): 823-828. | |
| 12 | Cumming K, Anderson D, Kaye K, et | Cost of MRSA |
| | al. Hand Hygiene Noncompliance | Infection |
| | and the Cost of Hospital-Acquired | |
| | Methicillin-Resistant | |
| | Staphylococcus aureus Infection. | |
| | Infection Control and Hospital | |
| | Epidemiology, 2010. 31(4): 357- | |
| | 364. | |
| 13 | Shorr A, Tabak Y, Killian A, et al. | Cost of MRSA |
| | Healthcare-associated bloodstream | CLABSI Infection |
| | infection: A distinct entity? Insights | |
| | from a large US database. Critical | |
| | Care Med, 2006. 34(10): 2588- | |
| | 2596. | |
| 14 | Warren D K, Quadir M M, | Cost of CLABSI |
| | Hollenbeak C S, Elward A M, et al, | Infection |
| | Attributable Cost of Catheter- | |
| | associated bloodstream infections | |
| | among intensive care patients in a | |
| | nonteaching hospital. Critical Care | |
| | Medicine 2006; 34: 2084-2089. | |
| 15 | Roberts R, Scott D, Hota B, et al. | Cost of ICU |
| | Costs Attributable to Healthcare- | Infections |
| | Acquired Infection in Hospitalized | |
| | Adults and a Comparison of | |
| | Economic Methods. Medical Care, | |
| | 2010. 48(11): 1026-1036. | |
| 16 | Bloom B T, Craddock A, Demore P M | Cost of NICU |
| | et al. Reducing Acquired Infections | Infections |
| | in the NICU: Observing and | |
| | Implementing Meaningful | |
| | Differences in Process Between | |
| | High and Low Acquired Infection | |
| | Rate Centers. J Perinatology 2003; | |
| | 23: 489-492. | |
| 17 | Carboneau C, Benge E, Jaco M, et | Cost of HAIs |
| | al. A lean Six Sigma Team Increases | |
| | Hand Hygiene Compliance and | |
| | Reduces Hospital-Acquired MRSA | |
| | Infections by 51%. Journal for | |
| | Healthcare Quality, 2010. 32(4): 61- | |
| | 71. | |
| 18 | Roberts R, Scott D, Hota B, et al. | HAI Mortality |
| | Costs Attributable to Healthcare- | Rate |
| | Acquired Infection in Hospitalized | |
| | Adults and a Comparison of | |
| | Economic Methods. Medical Care, | |
| | 2010. 48(11): 1026-1036. | |
| 19 | ICU MORTALITY RATE | |
| 20 | Sadowska-Krawczenko I, Jankoska | NICU Mortality |
| | A, Kurylak A. Healthcare associated | Rate |
| | infections in a neonatal intensive | |
| | care unit. Clinical Research, 2012. | |
| | 8(5): 854-858. | |
| 21 | Pastagia M, Kleinman L, Lacerda de | MRSA Non-CLABSI |
| | la Cruz E, et al. Predicting Risk for | Mortality Rate |
| | Death from MRSA Bacteremia. | |
| | Emerging Infectious Diseases, | |
| | 2012. 18(7): 1072-1071. | |
| 22 | Shorr A, Tabak Y, Killian A, et al. | CLABSI MRSA |
| | Healthcare-associated bloodstream | Mortality Rate |
| | infection: A distinct entity? Insights | |
| | from a large US database. Critical | |
| | Care Med, 2006. 34(10): 2588- | |
| | 2596. | |
| 23 | Shorr A, Tabak Y, Killian A, et al. | CLABSI Mortality |
| | Healthcare-associated bloodstream | Rate |
| | infection: A distinct entity? Insights | |
| | from a large US database. Critical | |
| | Care Med, 2006. 34(10): 2588- | |
| | 2596. | |
| 24 | Marra A, Edmond M, Wenzel R, et | C. Difficile |
| | al. Hospital-acquired Clostridium | Mortality Rate |
| | difficile-associated disease in the | |
| | intensive care unit setting: | |
| | epidemiology, clinical course and | |
| | outcome. BMC Infectious Diseases, | |
| | 2007. 4(42). | |
| 25 | Graf K, Ott E, Vonberg R, et al. | Increased LOS for |
| | Surgical site infections - economic | HAI |
| | consequences for the health care | |
| | system. Langenbecks Arch Surg, | |
| | 2011. 396: 453-459. | |
| 26 | ICU LOS | |
| 27 | Mahieu L M, Buitenweg N, Beutels | Increased LOS for |
| | P, et al. Additional hospital stay | NICU |
| | and charges due to hospital- | |
| | acquired infections in a neonatal | |
| | intensive care unit. Journal of | |
| | Hospital Infection, 2001. 47(3): 223- | |
| | 229. | |
| 28 | Cosgrove S, Sakoulas G, | Increased LOS for |
| | Perencevich E, et al. Comparison of | MRSA |
| | Mortality Associated with | |
| | Methicillin-Resistant and | |
| | Methicillin-Susceptible | |
| | Staphylococcus aureus Bacteremia: | |
| | A Meta-analysis. CID, 2003. 36: 53- | |
| | 60. | |
| 29 | Cosgrove S, Sakoulas G, | Increased LOS for |
| | Perencevich E, et al. Comparison of | CLASBI MRSA |
| | Mortality Associated with | |
| | Methicillin-Resistant and | |
| | Methicillin-Susceptible | |
| | Staphylococcus aureus Bacteremia: | |
| | A Meta-analysis. CID, 2003. 36: 53- | |
| | 60. | |
| 30 | LOS CLABSI | |
| 31 | Dubberke E, Butler A, Reske K, et | Increased LOS for |
| | al. Attributable Outcomes of | C. Difficile |
| | Endemic Clostridium difficile- | |
| | associated Disease in Nonsurgical | |
| | Patients. Emerging Infectious | |
| | Diseases, 2008. 14(7): 1031-1039. | |
| 32 | Elixhauser A, Jhung M. Clostridium | C. Difficile Read- |
| | Difficile-Associated Disease in US | missions Rate |
| | Hospitals, 1993-2005. Healthcare | |
| | Cost and Utilization Project, 2008. | |
| 33 | Scheithauer S, Haefner H, Schwanz | Hawthorne Effect |
| | T, Schulze-Steinen H, Schiefer J, | |
| | Koch A, Engels A, Lemmen S W, | |
| | Compliance with hand hygiene on | |
| | surgical, medical, and neurological | |
| | intensive care units: Direct | |
| | observation versus calculated | |
| | disinfectant usage. Am J Inf Co | |

Both clinical and financial benefits may be realized by the installation of an electronic hand hygiene compliance monitoring system shown by FIG. 18. FIG. 18 is a diagram showing a wireless information collection system that may be used to electronically monitor hand hygiene compliance. The DebMed® GMS™ monitoring system is an example of the monitoring system shown FIG. 18. More particularly, the electronic monitoring system 50 is a dispenser usage monitoring system that comprises one or more dispensers 30, a wireless monitoring network, and a data collection server 58. The system 50 may be that disclosed by U.S. Pat. No. 8,427,323, dispensers and a wireless communication system that report dispenser use may be those disclosed by U.S. patent application Ser. Nos. 12/823,475 and 13/427,467 which are assigned to the applicant of this application and are incorporated herein by reference. The system may determine hand hygiene compliance based on reported use of dispensers 30 based on the methods disclosed by U.S. patent application Ser. No. 13/669,998 and U.S. patent application Ser. No. 13/926,824, both of which are owned by the owner of this application and are also incorporated herein by reference.

In this example, the dispensers 30 are configured for communication over the wireless monitoring network. The depicted electronic monitoring system 50 includes a hub 54 and a gateway 56. The gateway 56 is connected to a data collation server 58. Data may be sent from the gateway 56 to the server 58 by way of a wired network (e.g. Ethernet based LAN or WLAN) and/or any cellular network such as available as part of the DebMed® GMS™ (e.g GSM via GPRS/EDGE/2g/3g/4g). U.S. patent application Ser. No. 13/427,467 which is assigned to the owner of this application and is incorporated herein by reference, describes dispensers that include wireless communication, a wireless monitoring network and data collation server. The dispensers 30, wireless network, and data collation server 58 of electronic monitoring system 50 may operate as described by that application. Other electronic compliance monitoring systems may also be used.

The electronic monitoring system 50 may also include a reporting panel 20 that is near and associated with one or more dispensers 30. The reporting panel 20 reports which of a number of guidelines or circumstances are selected by a user as a basis for use of an associated dispenser 30. The reporting panel 20 comprises a transmitter that wirelessly reports the selected basis to the electronic monitoring system 50 that, in turn, forwards transmissions to the data collation server 58.

Each reporting panel 20 may be capable of storing data related to, for example, 100 or more selections. However, the selections depend on the needs of each reporting panel. Reporting panels may store data relating to selections of guidelines or circumstances for only a few hand selections. Each dispenser 30 may be capable of storing data related to, for example, 100 or more activations. This minimizes the chance of losing data in the event of queuing for receipt by the hub 54. The data is sent between the reporting panel 20 and the hub 54 and between the hub 54 and the gateway 56 in data packets which may be time or memory dependent.

As will be evident, the number of dispensers 30 and reporting panels 20 may be determined based on need of a healthcare institution. Those numbers may be based on number of locations at which hand hygiene should occur and locations at which the benefit of improved compliance is indicated by determinations described above. The evaluation described above is by design and necessity directed to individual facilities characteristics and needs. The evaluations provide a basis for informed decisions to improve both clinical performance and financial efficiency of the facility.

The electronic monitoring system 50 reports use of dispensers and identifies the dispensers that were used. That data may be used by the healthcare facility to identify locations within the healthcare facility at which hand hygiene compliance may be improved.

The present invention is not limited to embodiments described herein. By way of example, the monitoring systems contemplated by this invention are not limited to described technologies.

1. A method for reducing healthcare-associated infections in a healthcare facility, the method comprising:
determining the current compliance with one or more of existing hand hygiene guidelines and best practices within a healthcare institution;
determining the potential for improved hand hygiene compliance on incidence of healthcare-associated infections by comparing current compliance with compliance experienced by facilities after installation and operation of an electronic monitoring system;
installing an electronic hand hygiene monitoring system; and
using the electronic monitoring system to monitor hand hygiene compliance within the institution.

2. The method of claim 1 further comprising using the hand hygiene monitoring system to identify locations within the healthcare facility at which one or more of hand hygiene guidelines and best practices are not complied with.

3. The method of claim 1 further comprising determining the costs to the institution of poor compliance with one or more of existing hand hygiene guidelines and best practices within the institution.

4. The method of claim 3 may further comprise determining the return on investment in an electronic monitoring system based on avoidance of costs to the facility of poor hand hygiene compliance.

5. A method for reducing healthcare-associated infections in a healthcare facility, the method comprising:
determining compliance of a healthcare facility with one or more of hand hygiene guidelines and best practices based on one or more of
manual hand hygiene compliance monitoring; and
other monitoring data information for the healthcare facility;
determining a potential improvement of the institution's hand hygiene compliance by comparing the healthcare facility hand hygiene compliance to compliance rates that have been experienced with electronic monitoring of hand hygiene;
determining healthcare institution's current rates healthcare-associated infections;
determining the reduction of healthcare-associated infections based on the potential improvement of the institution's hand hygiene compliance;
determining the cost benefit to the institution of the electronic hand hygiene monitoring system by determining the difference in cost to the institution of the cost of hand hygiene at the current compliance and the cost to the institution of improved hand hygiene compliance and the effects of improved hand hygiene to decrease rates of healthcare-acquired infections within the healthcare institution; and
installing an electronic hand hygiene monitoring system in the healthcare facility.

6. The method of claim 5 further comprising prior to installing an electronic hand hygiene monitoring system determining the return on investment by determining the difference between the total costs to the institution of an electronic hand hygiene monitoring and the total costs for direct (manual) observation monitoring taking into account the expected reduction of infections and associated costs when the electronic hand hygiene compliance monitoring system is installed.

7. The method of claim 5 wherein the step of determining the cost benefit to the institution of the electronic hand hygiene monitoring system is based on decrease healthcare-acquired infections reported at healthcare facilities when hand hygiene compliance improves.
